(19) United States
(12) Patent Application Publication
(10) Pub. No.: US 2026/0243442 A1
(43) Pub. Date: Aug. 20, 2026

(54) DRY HOT WATER ONDOL PANEL

(71) Applicant: Young Ho WHANG, Gwangju-si (KR)

(72) Inventor: Young Ho WHANG, Gwangju-si (KR)

(21) Appl. No.: 19/481,508

(22) PCT Filed: Apr. 12, 2024
(86) PCT No.: PCT/KR2024/004953

§ 371 Date: Nov. 10, 2025

(30) Foreign Application Priority Data
May 3, 2023 (KR) 10-2023-0057996

(51) Int. Cl. F24D 3/14; E04B 5/48; F16L 3/26

(52) U.S. Cl. CPC F24D 3/145; E04B 5/48; F16L 3/26

(57) ABSTRACT

The present invention relates to a dry hot water ondol panel in which a hose-accommodating groove of a bottom panel is finished with a hose finishing so that the upper surface of the bottom panel and the entire upper surface of the hose finishing are kept flat on the same line while covering the hose, thus making it possible to construct a decorative floor or panel without the floor or panel lifting. Also, loosening or upward rattling between the bottom panel and the finishing due to thermal expansion and contraction can be minimized, and thus creaking that occurs when walking on the panel can be eliminated.

### TECHNICAL FIELD

The present invention relates to a dry hot water ondol panel in which a hose-accommodating groove of a bottom panel is finished with a hose finishing so that the upper surface of the bottom panel and the entire upper surface of the hose finishing are kept flat on the same line while covering the hose, thus making it possible to construct a decorative floor or panel without the floor or panel lifting. Also, loosening or upward rattling between the bottom panel and the finishing due to thermal expansion and contraction can be minimized, and thus creaking that occurs when walking on the panel can be eliminated.

### BACKGROUND ART

A conventional prefabricated ondol panel is disclosed in the patent document (for example, Korean Utility Model Publication No. 20-2008-0004185).

Referring to FIGS. 8 and 9, the prefabricated ondol panel of the above patent document includes: a lower panel 20 installed on a foundation floor and provided with a pipe installation groove 22 for installing a heat medium pipe 1; the heat medium pipe 1 installed inserted into the pipe installation groove 22 of the lower panel 20; and an upper panel 10 positioned above the lower panel 20 and formed therein with a pipe installation groove 12 to surround the heat medium pipe 1.

A plurality of fastening grooves 24 are formed on the lower panel 20 and a plurality of fastening protrusions 14 are formed correspondingly on the upper panel 10, so that the fastening protrusions 14 are inserted into and coupled to the fastening grooves 24.

The lower panel 20 and the upper panel 10 are formed therein with pipe installation grooves 22 and 12, respectively, between which the heat medium pipe 1 is fitted and coupled, in which pipe installation grooves 22 and 12 are formed with straight installation grooves 22a and 12a and curved installation grooves 22b and 12b to communicate with each other.

A surface finishing member 2 is installed on an upper part of the upper panel 10, and the surface finishing member 2 may include a decorative tile, plywood flooring, flooring board or the like applied with an adhesive to and spread on a top surface of the upper panel 10.

The above conventional prefabricated ondol panel has the following problems.

First, when thermal expansion or contraction occurs in the upper panel 10 with respect to the lower panel 20, the upper panel 10 are rattled upward, and accordingly, in particular, joints as borders between decorative tiles bonded with adhesives or the like may be lifted upward.

Second, when the upper panel 10 is rattled upward due to thermal expansion or becomes loose due to thermal contraction with respect to the lower panel 20, the gap therebetween may cause a creaking sound when a person walks thereon.

### DISCLOSURE

### Technical Problem

An object of the present invention is to solve the above-mentioned problems and other problems.

An object of the present invention is to provide a dry hot water ondol panel for removing rattling upward due to thermal expansion or contraction to have excellent workability of finishing materials, especially the tiles, and minimizing looseness and distortion to prevent creaking noises and the like during walking thereon.

### Technical Solution

One aspect of the present invention for achieving the above or other objects provides a dry hot water ondol panel including a bottom panel formed therein with a hose-accommodating groove for accommodating a hose, and a hose finishing part for finishing an inside of the hose-accommodating groove to cover an upper surface of the hose, wherein a top surface of the bottom panel and a top surface of the hose finishing part are arranged on the same line.

### Advantageous Effects

The advantageous effects of the dry hot water ondol panel according to the present invention will be described as follows.

Because only the hose-accommodating groove is covered with the hose cover plate, the hose cover plate serves as a partial component of the bottom panel to function only as a bottom panel without a cover, so that the upward rattling due to heat shrinkage or expansion can be prevented. Accordingly, finishing materials, especially decorative tiles or synthetic flooring having borders, can be very excellently installed on the top surface of the bottom panel.

In addition, the hose cover plate is fitted into the hose-accommodating groove and the top surfaces are arranged on the same line, so that the flat surface can be maintained without wobbling when the finishing material is installed, and the adhesive can be applied evenly to the top surface of the hose cover plate and the top surface of the bottom panel.

In particular, when decorative tiles are bonded with the adhesive, the adhesive is not filled inside the hose-accommodating groove due to the hose cover plate, so that the installation can be conducted cleanly.

In addition, because the hose cover plate is fitted into the hose-accommodating groove, the panel is restrained except for the upper part, so that risk of warping or spacing can be absolutely prevented.

In addition, the hose cover plate is fastened to a guide block, thereby preventing the hose cover plate from moving in all directions, so that creaking noises caused by expansion or contraction can be blocked.

In addition, a central through-hole of the hose cover plate having first to fourth quadrants is fitted to the bottom panel, thereby further suppressing deformation due to thermal expansion or contraction, so that warping and upward rattling can be completely prevented.

In addition, a partition line is formed on the top surface of the hose cover plate to enable an installation worker to clearly confirm a border between a step and a hose with the naked eye, place a plywood or the like thereon and fix nails or tacks only into the step, so that the hose can be stably accommodated.

Meanwhile, when the inside of the hose-accommodating groove is filled with mortar instead of the hose cover plate and cured, the mortar functions as a heat storage material, so that the efficiency of the ondol can be further improved.

In addition, when mortar is poured in the hose-accommodating groove and scraped against the top surface of the bottom panel, the mortar is easily arranged in the same line as the top surface of the bottom panel, so that the mortar can be cleanly plastered even by an unskilled person.

### DESCRIPTION OF DRAWINGS

FIGS. 1 and 2 are combination and separation perspective views showing a minimum unit dry hot water ondol panel 100 according to one embodiment of the present invention.

FIG. 3 is a perspective view showing a basic dry hot water ondol panel 1000 according to one embodiment of the present invention.

FIG. 4 is a perspective view showing a basic hose cover plate of FIG. 3.

FIG. 5 is a sectional view taken along line 5-5 of FIG. 3.

FIG. 6 is a perspective view showing another example of the basic hose cover plate of FIG. 4.

FIG. 7 is a sectional view according to another embodiment of FIG. 5.

FIG. 8 is an exploded perspective view showing a conventional prefabricated ondol panel.

FIG. 9 is a sectional view of the combination of FIG. 8.

### BEST MODEL

### Mode for Invention

Hereinafter, the embodiment disclosed in the description will be described in detail with reference to the accompanying drawings. Same reference numerals in different drawings may indicate the same or similar elements, and a duplicate description thereof will be omitted. The suffix such as “module” and “unit” for components used in the following description is given or mixed merely to facilitate description of the specification, and the suffix itself is not intended to give any meaning or function to differentiate the components with each other. Further, in the following description of the embodiments disclosed in the present specification, a detailed description of a related known technology incorporated herein will be omitted when it possibly makes the subject matter of the embodiments disclosed in the present specification unclear. In addition, the accompanying drawings are only intended to facilitate understanding of the embodiments disclosed in the present specification, and the technical idea disclosed in the present specification is not limited by the accompanying drawings. It will be understood to include all modifications, equivalents, or substitutes included in the idea and technical scope of the present invention.

The terms including an ordinal number such as first and second may be used to describe various components, however, these components are not limited by the above-mentioned terms. The terms are used only for the purpose of distinguishing one component from another component.

When one component is recited to be “connected” or “linked” to other component, it will be understood that the one component may be directly connected to or linked to the other component, but another component may be present therebetween. On the other hand, when one component is recited to be “directly connected” or “directly linked” to other component, it will be understood that another component is not present therebetween.

The singular expression includes a plural expression unless the context clearly means otherwise.

Herein, it will be understood that the term such as “include” or “have” is intended to designate the presence of a feature, number, step, component, part or a combination thereof recited in the specification, and does not preclude the possibility of the presence or addition of one or more other features, numbers, steps, components, parts or combinations thereof.

In the drawings, sizes of components may be exaggerated or reduced for convenience of description. For example, the size and thickness of each component shown in the drawing are arbitrarily shown for convenience of description, and therefore the present invention is not necessarily limited to the shown drawing.

In some embodiments, where implementations are otherwise feasible, a specific process sequence may be performed in a sequence different from a described sequence. For example, two processes described sequentially may be performed substantially simultaneously, or may proceed in a reverse sequence to the described sequence.

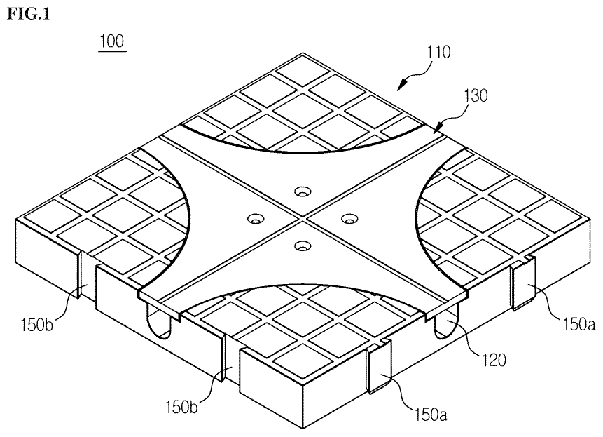

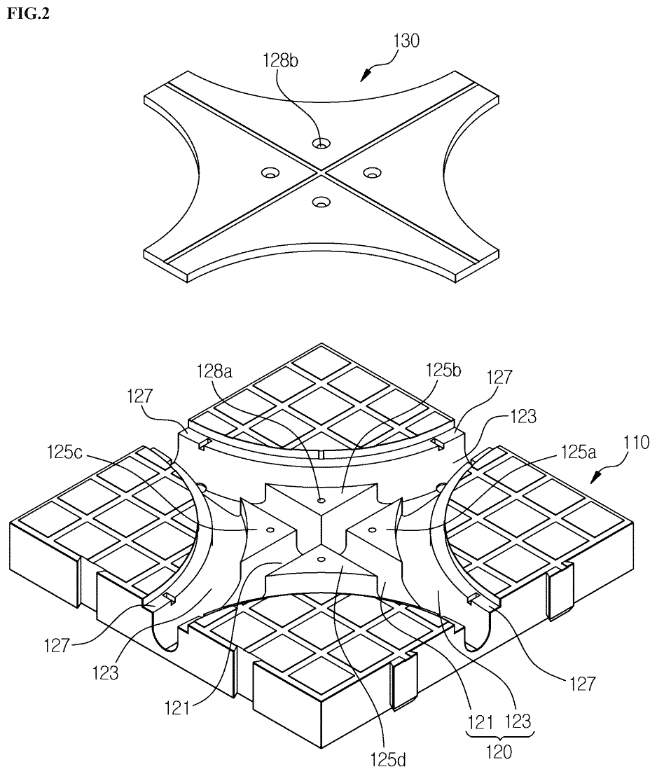

FIGS. 1 and 2 are combination and separation perspective views of a minimum unit dry hot water ondol panel 100 according to an embodiment of the present invention when viewed from the top view.

Referring to FIGS. 1 and 2, the minimum unit dry hot water ondol panel 100 according to the embodiment of the present invention may include a minimum unit bottom panel 110. The minimum unit bottom panel 110 may be an injection molded panel formed of an insulating material. The minimum unit bottom panel 110 may be laid on a floor or attached to a wall.

Referring to FIGS. 1 and 2, the minimum unit bottom panel 110 may be rectangular. For example, the minimum unit bottom panel 110 may be square.

The minimum unit bottom panel 110 may include a hose-accommodating groove 120 in which a hose H is accommodated. The hose-accommodating groove 120 may be configured as a U-shaped groove concave downward. The hose-accommodating groove 120 may have a depth at least equal to or deeper than a diameter of the hose H. The hose-accommodating groove 120 may be formed on a central upper surface of the minimum unit bottom panel 110.

The hose-accommodating groove 120 may include a straight hose-accommodating groove 121. The straight hose-accommodating groove 121 may have a cross-shaped intersection shape.

The hose-accommodating groove 120 may include a curved hose-accommodating groove 123. The curved hose-accommodating groove 123 may be formed on an outer side of the straight hose-accommodating groove 121. The curved hose-accommodating groove 123 may directly or indirectly communicate with the straight hose-accommodating groove 121.

First to fourth guide blocks 125a to 125d may be formed between the straight hose-accommodating groove 121 and the curved hose-accommodating groove 123. The first to fourth guide blocks 125a to 125d may be formed in first to fourth quadrants, respectively, about a center of the straight hose-accommodating groove 121.

The minimum unit bottom panel 110 may be formed with a joint coupling protrusion 150a and a joint coupling groove 150b. The joint coupling protrusion 150a and the joint coupling groove 150b may be formed on sides of the minimum unit bottom panel 110. The joint coupling protrusion 150a and the joint coupling groove 150b may have a double-tail shape. Accordingly, the minimum unit bottom panels 110 may be firmly connected and jointed to each other through the joint coupling protrusion 150a and the joint coupling groove 150b.

Referring to FIGS. 1 and 2, the minimum unit dry hot water ondol panel 100 according to one embodiment of the present invention may include a minimum unit hose cover plate 130. The minimum unit hose cover plate 130 may be formed of an injection-molded insulating material, iron plate or the like. The minimum unit hose cover plate 130 may cover an upper side of the hose-accommodating groove 120. In other words, the minimum unit hose cover plate 130 may function as a partial cover plate of the minimum unit bottom panel 110.

A bottom surface of an edge of the minimum unit hose cover plate 130 may be fitted to a top surface of a step 127 of the hose-accommodating groove 120. The step 127 may be formed on an inner side of the curved hose-accommodating groove 123. Due to the above configuration of the step 127, as shown in FIG. 5, a top surface 1111 of a basic unit bottom panel 1100 and a top surface 1135 of a basic unit hose cover plate 1130 may be placed on the same line so as to be flat. In other words, the diameter of the hose H may be accommodated in the hose-accommodating groove 120 without exceeding the step 127.

In addition, a central bottom surface of the minimum unit hose cover plate 130 may be placed on top surfaces of the first to fourth guide blocks 125a to 125d.

In addition, the minimum unit hose cover plate 130 may be fastened to the first to fourth guide blocks 125a to 125d by using screws. To this end, fastening grooves 128a may be formed in the first to fourth guide blocks 125a to 125d, and fastening holes 128b may be formed in the minimum unit hose cover plate 130.

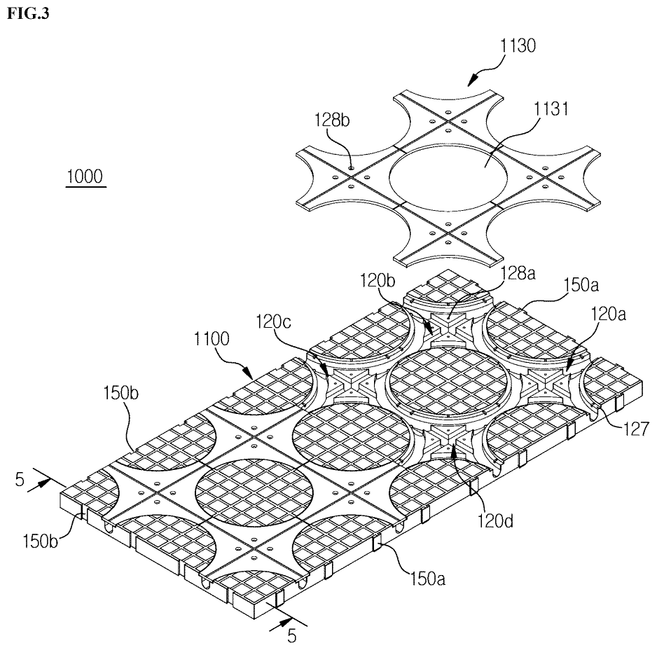

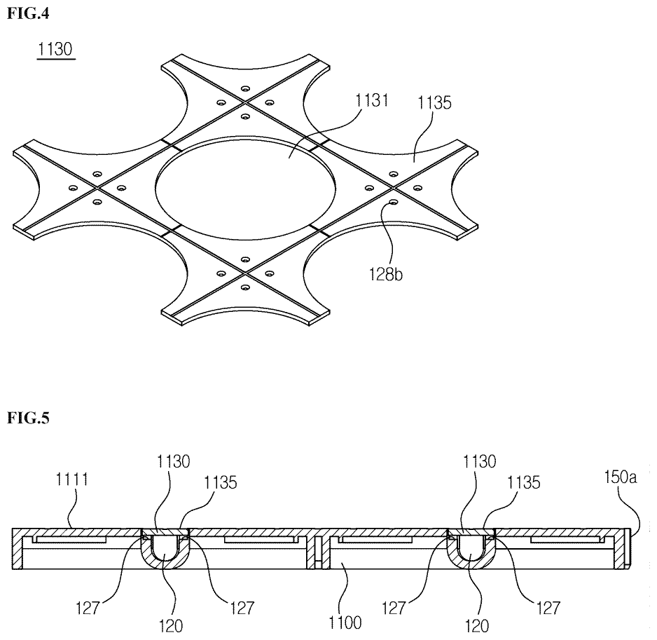

FIG. 3 is a perspective view showing a basic dry hot water ondol panel 1000 according to the embodiment of the present invention, and FIG. 4 is a perspective view showing a basic hose cover plate of FIG. 3.

Referring to FIGS. 3 and 4, the basic dry hot water ondol panel 1000 according to the present embodiment may have a form in which the minimum unit dry hot water ondol panels 100 extend lengthwise and breadthwise. For example, the width of the basic dry hot water ondol panel 1000 may be configured as one sheet formed of two minimum unit dry hot water ondol panels 100. In addition, the length of the basic dry hot water ondol panel 1000 may be configured as one sheet formed of four minimum unit dry hot water ondol panels 100. In other words, the basic dry hot water ondol panel (1000) may be a rectangle arranged by two breadthwise and four lengthwise sheets of the minimum unit dry hot water ondol panels 100.

Referring to FIG. 3, the basic dry hot water ondol panel 1000 may include a basic bottom panel 1100. The basic bottom panel 1100 may be similar to eight minimum unit bottom panels 110 attached to each other.

Like the minimum unit bottom panel 110, the basic bottom panel 1100 may include a hose-accommodating groove 120, a joint coupling protrusion 150a and a joint coupling groove 150b.

As shown in FIG. 3, the hose-accommodating groove 120 may be formed as first to fourth quadrant hose-accommodating grooves 120a to 120d mutually communicate with the first to fourth quadrants of the basic bottom panel 1100.

Referring to FIG. 4, the basic dry hot water ondol panel 1000 may include a basic hose cover plate 1130. The basic hose cover plate 1130 may be similar to four minimum unit hose cover plates 130 attached to each other. Accordingly, the basic hose cover plate 1130 may simultaneously cover the hose-accommodating grooves 120a to 120d in the first to fourth quadrants. In addition, a central through-hole 1131 of the basic hose cover plate 1130 may be fitted to the basic bottom panel 1100 to suppress deformation due to thermal expansion or contraction.

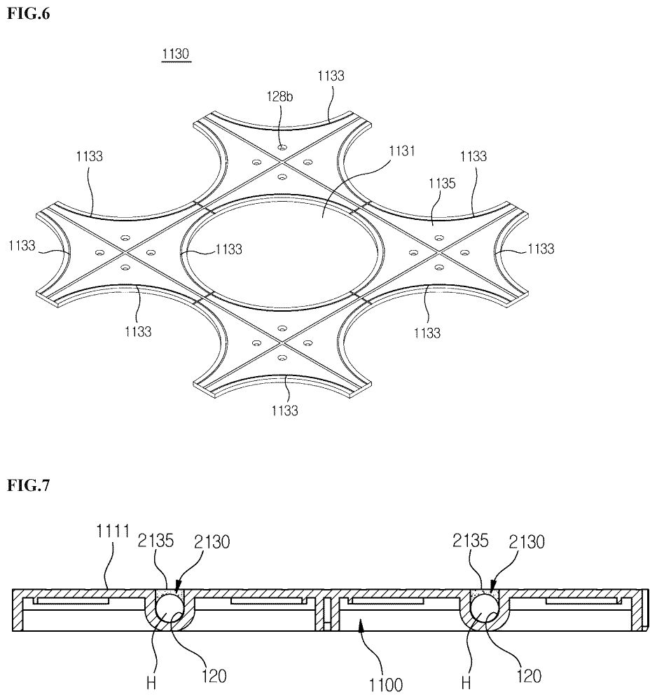

Meanwhile, FIG. 6 shows that a partition line 1133 may be formed on the top surface 1135 of the basic hose cover plate 1130. The partition line 1133 may be a line for partitioning the step 127 and the hose H. The partition line 1133 may be formed as a groove with a thin depth.

The partition line 1133 may be a portion that does not extend beyond the step 127 on which the basic hose cover plate 1130 is placed. Accordingly, the partition line 1133 enables the installation worker to visually check the step 127 without the hose H, place a plywood or the like thereon top, and fix nails or tackers to the step 127 only, so that the hose H may be reliably protected.

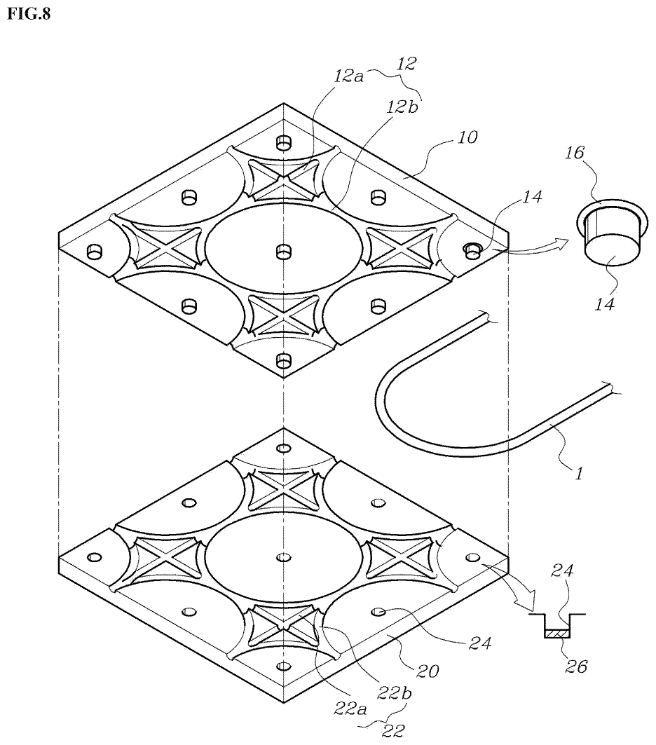

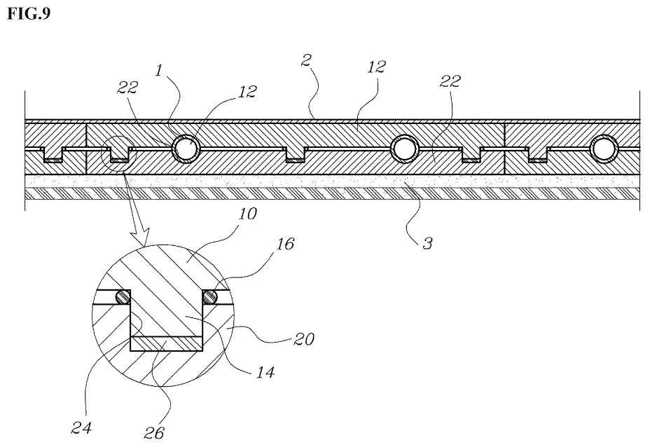

Meanwhile, referring to FIG. 7, a basic mortar part 2130 in which mortar is poured and cured in the hose-accommodating groove 120 may be configured to substitute the basic hose cover plate 1130 as the hose finishing part. In other words, when the mortar is poured to the hose-accommodating groove 120 to be fully filled or overflow, and then scraped off based on the top surface 1111 of the bottom panel 1100 (this is like the situation that a heap of rice is put in a rice bowl and the upper portion thereof is scraped by using a stick), a top surface 2135 of the basic mortar part 2130 having the same height as the top surface 1111 of the bottom panel 1100 may be simply formed. Accordingly, the cured mortar part 2130 may be optimized for the ondol because of not only serving as the hose cover plate 1130 but also functioning as a heat storage material.

Any of the above-described embodiments or other embodiments of the present invention are neither exclusive nor distinct from each other. Any of the above-described embodiments or other embodiments of the present invention may be combined or used in combination with each other in their respective configurations or functions.

It will be apparent to those skilled in the art that the present invention may be embodied in other specific forms without departing from the spirit and essential characteristics of the present invention. The above detailed description will not be construed as limiting in all aspects, but will be considered as illustrative. The scope of the present invention will be determined by a reasonable interpretation of the appended claims, and all changes within the equivalent scope of the present invention are included in the scope of the present invention.

1. A dry hot water ondol panel comprising:
a bottom panel formed therein with a hose-accommodating groove for accommodating a hose; and
a hose finishing part for finishing an inside of the hose-accommodating groove to cover an upper surface of the hose, wherein
a top surface of the bottom panel and a top surface of the hose finishing part are arranged on a same line.

2. The dry hot water ondol panel of claim 1, wherein the hose finishing part includes a hose cover plate fitted to an inner side of the hose-accommodating groove to cover the upper surface of the hose, and
the upper surface of the bottom panel and a top surface of the hose cover plate are arranged on the same line.

3. The dry hot water ondol panel of claim 2, wherein the hose-accommodating groove includes a straight hose-accommodating groove and a curved hose-accommodating groove formed to communicate with each other, and
the curved hose-accommodating groove is formed inside thereof with a step on which an edge of the hose cover plate is placed.

4. The dry hot water ondol panel of claim 3, wherein the straight hose-accommodating groove and the curved hose-accommodating groove are formed therebetween with guide blocks, and
the hose cover plate has a bottom surface placed and fastened onto top surfaces of the guide blocks.

5. The dry hot water ondol panel of claim 4, wherein the hose-accommodating groove includes first to fourth quadrant hose-accommodating grooves in first to fourth quadrants of the bottom panel to communicate with each other,
the hose cover plate includes first to fourth quadrant hose cover plates for covering the first to fourth quadrant hose-accommodating grooves,
the first to fourth quadrant hose cover plates are integrally formed, and
the first to fourth quadrant hose cover plates has a central through-hole fitted to the bottom panel.

6. The dry hot water ondol panel of claim 2, wherein the top surface of the hose cover plate is formed therein with a partition line, and
the partition line defines a border between the step and the hose.

7. The dry hot water ondol panel of claim 1, wherein the hose finishing part includes a hose mortar material filled and cured inside the hose-accommodating groove to cover the upper surface of the hose, and
the top surface of the bottom panel and a top surface of the hose mortar material are arranged on the same line.
